(19) United States
(12) Patent Application Publication
(10) Pub. No.: US 2015/0041340 A1
(43) Pub. Date: Feb. 12, 2015

(54) COMBINATION PROTECTIVE JACKET AND SPACER DEVICE FOR DATA STORAGE CARDS

(71) Applicants: Tristan Greenwalt, Beaufort, SC (US); Angela Greenwalt, Beaufort, SC (US)

(72) Inventors: Tristan Greenwalt, Beaufort, SC (US); Angela Greenwalt, Beaufort, SC (US)

(21) Appl. No.: 13/963,309

(22) Filed: Aug. 9, 2013

(51) Int. Cl. A45C 11/18; C09J 7/02

(52) U.S. Cl. CPC A45C 11/182; C09J 7/02
USPC 206/37; 428/343; 428/335; 428/41.8

(57) ABSTRACT

A protective jacket or sleeve for data storage cards. The jacket includes a planar body having an open side edge leading into an interior space for accommodating and protecting a data storage card, such as a debit or credit card. The jacket is constructed from a flexible, clear or transparent non-ferromagnetic or non-magnetically attractive sheet of material configured to allow passage/transmission of magnetic signals from the data storage card to a data storage card reader.

### RELATED APPLICATIONS

There are no previously filed, nor currently any co-pending applications, anywhere in the world.

### BACKGROUND OF THE INVENTION

1. Field of the Invention

The present invention relates generally to protective holders for data storage cards, and more particularly, to a protective jacket for data storage cards configured to allow passage/transmission of magnetic signals to a corresponding card reader.

2. Description of the Related Art

Currently there exist in the art various devices and methods for protecting data storage cards. Data storage cards, such as transaction cards, typically include a magnetic stripe or strip, integrated circuit, radio frequency antenna integrated circuit and related components, or other means for storing data and information relating to the transaction card. Information typically related to and stored on the transaction card includes a security code, and information associated with an account or an amount of money that the transaction card may represent. For example, in the event the transaction card is a credit card, the information contained on the magnetic stripe may relate to an account whereby use of the credit card may alert the account to release funds for the purchase of goods or services. In addition, the magnetic stripe or other means may further contain any other information to allow the transaction card to be utilized and processed. The transaction card is typically fed into, through, or scanned by a data storage card reader which reads the information contained on the magnetic stripe to extract the requisite information when the transaction card is being used.

A magnetic stripe is the black or brown horizontal stripe area typically disposed about the rear side of a data storage card. The stripe is made up of tiny magnetic particles in a resin. The particles are either applied directly to the card or made into a stripe on a plastic backing which is applied to the card.

The material used to make the particles defines the coercivity of the stripe. Standard low coercivity stripes use iron oxide as the material to make the particles, while high coercivity stripes are made from other materials like barium ferrite. These materials are mixed with a resin to form a uniform slurry which is then coated onto a substrate. In the case of a credit card or similar application, the slurry is usually coated onto a wide plastic sheet and dried. The coating is very thin and the plastic allows the coating to be handled. The coating is then sliced into stripe widths and applied to the card during the card manufacturing process. The methods of application typically include lamination (where the stripe and backing is laminated into the card), hot-stamp (where a heated die is used to transfer the oxide stripe from the backing onto the card after the card is cut to size), and cold-peel (where the oxide stripe is peeled from the backing, and then laminated into the card).

Significantly, the magnetic stripe can be easily damaged in many ways, including exposure to a large external magnetic field, such as via a permanent magnet, or a high-strength alternating current. Damage may also occur by a gradual “smearing” process, in which some of the magnetic particles in the stripe are physically dragged from one zone of the stripe to another. The dragging of some of the magnetic particles causes some of the magnetized particles to be transferred from its domicile zone and into zones of the stripe which previously had no magnetized particles, thereby corrupting the data and information stored in the stripe and preventing the transaction card from being read by a transaction card reading device. The above-described “smearing” process is by far the most common mode of card failure, and such process is likely underway on most transaction cards.

While the prior art has taught various covers and cases for protecting data storage cards, it has failed to disclose or teach a jacket or sleeve for both protecting data and information stored thereon, and which allows the data storage card to be read by a data storage card reader while being housed in the jacket.

Accordingly, a need exists for an improved data storage card holder for protecting data storage cards. The development of the protective jacket or sleeve for data storage cards fulfills this need.

A search of the prior art did not disclose any patents that read directly on the claims of the instant invention; however, the following references were considered related:

U.S. Pat. No. 6,845,863 B1, issued in the name of Riley;

U.S. Pat. No. 7,385,508 B1, issued in the name of Ray et al.;

U.S. Pat. No. 7,721,956 B2, issued in the name of Williams et al.;

U.S. Pat. No. 7,161,747 B2, issued in the name of Yang, Jr.;

U.S. Pat. No. 6,969,006 B1, issued in the name of Smith, Sr.;

U.S. Pat. No. 5,941,375, issued in the name of Kamens et al.;

U.S. Pat. No. 6,857,569 B1, issued in the name of Smith, Sr. et al.; and

U.S. Pat. No. 6,871,787 B1, issued in the name of Smith, Sr.

This application presents claims and embodiments that fulfill a need or needs not yet satisfied by the products, inventions and methods previously or presently available. In particular, the claims and embodiments disclosed herein describe a protective jacket for data storage cards, the jacket comprising: a flexible planar body, the body comprising an open side edge providing direct, unobstructed passage to an interior space within which a data storage card is housed for the protection, the jacket being constructed of a flexible, clear, or transparent non-ferromagnetic or non-magnetically attractive sheet of material configured to allow passage/transmission of magnetic signals from the data storage card to a data storage card reader, the combination protective jacket and spacer device for data storage cards providing unanticipated and nonobvious combination of features distinguished from the products, inventions and methods preexisting in the art. The applicant is unaware of any product, method, disclosure or reference that discloses the features of the claims and embodiments disclosed herein.

### SUMMARY OF THE INVENTION

Briefly described according to one embodiment of the present invention, a protective jacket or sleeve for data storage cards is disclosed. The jacket comprises a flexible planar body comprising an open side edge providing direct, unobstructed passage to an interior space within which a data storage card is housed for the protection thereof. The jacket is constructed from a flexible, clear, or transparent non-ferromagnetic or non-magnetically attractive sheet of material configured to allow passage/transmission of magnetic signals from the data storage card to a data storage card reader.

In accordance to another embodiment of the present invention, a spacer device is disclosed. Releasable attachment of the spacer device atop the data storage area or zone of a data storage card containing corrupted data, allows the data storage card to be successfully read by the data storage card reader.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a combination protective jacket and spacer device for data storage cards, according to one embodiment of the present invention;

FIG. 2 is a plan view of the jacket illustrating the front panel thereof, in accordance to one embodiment of the present invention;

FIG. 2A is a plan view of the jacket illustrating the rear panel thereof, in accordance to one embodiment of the present invention;

FIG. 3 is a front side elevational view of an encodeable card;

FIG. 4 is a rear side elevational view of an encodeable card;

FIG. 4A is a rear side elevational view of a debit card shown with a bar code disposed on the converse surface thereof;

FIG. 5 is a front side elevational view of a smart card,

FIG. 5A is a right side elevational view of a smart card;

FIG. 5B is a right side elevational view of the smart card of FIG. 5.

FIGS. 6A-C illustrate various data storage card reading devices;

FIG. 7 is a cross-sectional view, on an enlarged scale, of the open side edge of the jacket illustrating a data storage card positioned in the interior space thereof, in accordance to one embodiment of the present invention;

FIG. 8A is a cross-sectional view of a spacer device, in accordance to another embodiment of the present invention; and

FIG. 8B is a rear side elevational view of a data storage card shown with a spacer device removably attached atop and covering the data storage zone thereof, in accordance to one embodiment of the present invention.

### DESCRIPTION OF THE PREFERRED EMBODIMENT

### Detailed Description of the Figures

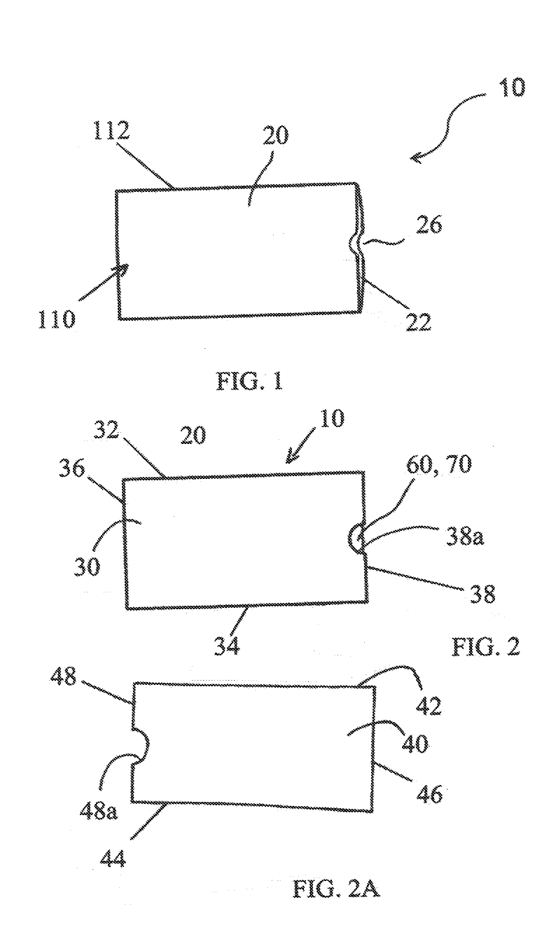

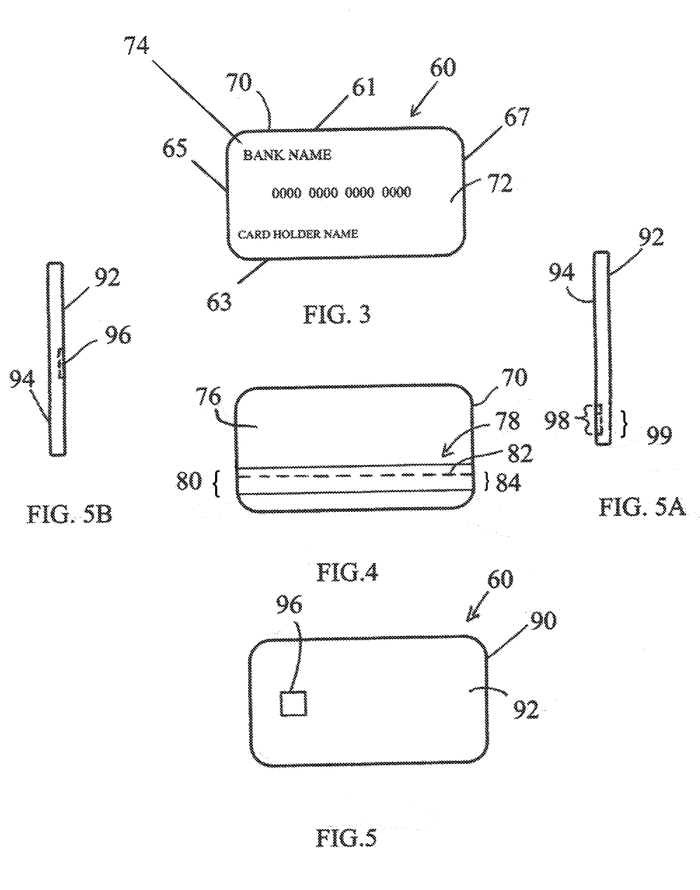

Referring now to FIGS. 1-4A, a protective sleeve or jacket for data storage cards, generally designated at 10 is disclosed, in accordance to one embodiment of the present invention.

Data storage cards, such as financial or transaction cards and non-financial cards are encoded with machine readable data and information. More specifically, a data storage card 60 is defined as a magnetically encodeable card 70 which functions primarily as financial credit cards. The magnetically encodeable card 70 has an obverse side 72 or surface disposed with indicia 74, e.g. user/cardholder name and/or financial institution or bank information, card account number, and a converse side 76 or surface comprising an encoding section, shown generally as 78. Data storage cards 60 further typically include an upper edge 61, a lower edge 63, and opposing side edges 65 and 67.

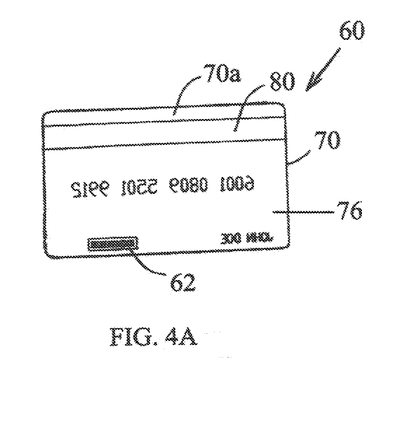

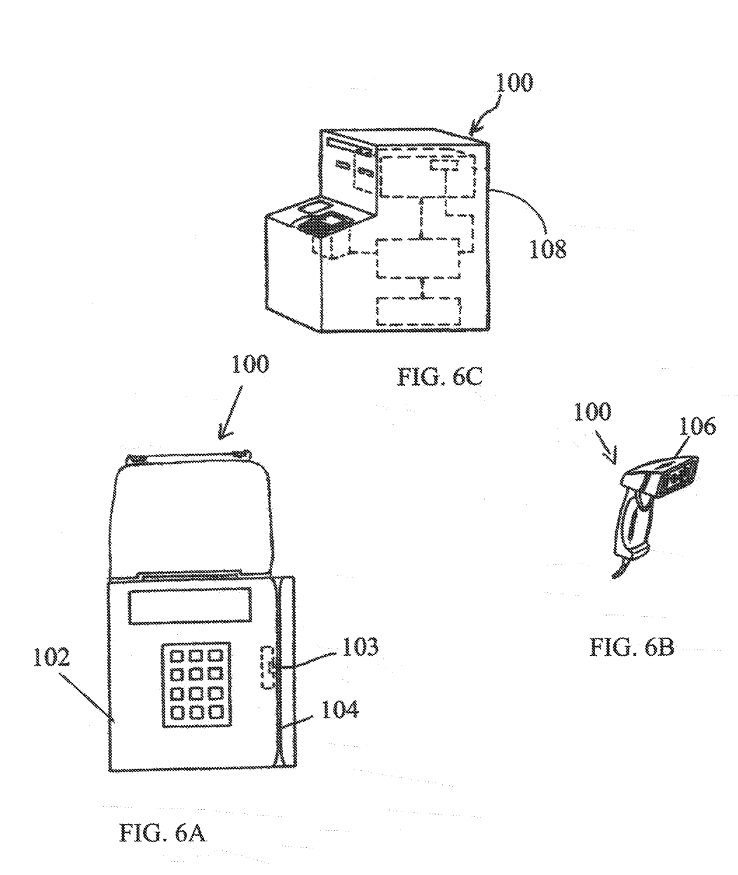

Data storage cards 60 are further defined as cards having bar codes 62 disposed on either the obverse side 72 or surface thereof, or the converse side 76 or surface thereof, such as the debit card 70a shown in FIG. 4A, wherein the bar code 62 is disposed along the converse side 76 thereof. The bar code 62 includes machine readable information and data being readable by a bar code reading device, such as including, but not limited to an optical scanner 106 (FIG. 6B).

In order to ensure magnetically encoded cards 70 are readable by standard card reading devices 100, the magnetically encoded cards 70 cards are constructed in accordance with standards promulgated by the American National Standards Institute, Inc. (“ANSI”). Various data storage card reading devices 100 are illustrated in FIGS. 6A-6C. FIG. 6A illustrates a card reader terminal 102 having a reading head assembly 103 and a card reading slot 104, FIG. 6B illustrates a hand held scanner or reader 106, and FIG. 6C illustrates a conventional ATM machine 108.

The encoding section 78 generally comprises a wide magnetic stripe zone 80 as shown on the converse side 76 of the data storage card 60 in FIG. 4. The terms “financial cards” generally include general purpose financial credit cards, e.g. VISA®, AMERICAN EXPRESS®, MASTERCARD®, debit cards, automatic teller machine (“ATM”) cards, and specific or special purpose credit cards, such as including, but not limited to gasoline and oil company cards, department store cards, car rental cards, hotel cards, airline cards, and the like.

Alternatively, a narrow magnetic stripe zone 84, as demarcated by dashed line 82 shown in FIG. 4, defining a narrow magnetic stripe area, is used by Visa® and most other credit cards. Typically, the substrate for both the VISA® credit card and the AMEX® credit card is formed of polyvinyl chloride (“PVC”) and/or polyvinyl chloride acetate (“PVCA”). VISA®, AMERICAN EXPRESS® and other financial institutions make wide use of magnetically encoded cards 70 for financial transactions.

An additional data storage card 60 used for credit and/or banking transactions is a Smart Card 90 illustrated in FIGS. 5A through 5C. The typical Smart Card 90 has an integrated circuit shown as 96 located on the obverse side 92 thereof. The integrated circuit 96 may include a dedicated storage medium. The converse side 94 of the Smart Card 90 may be blank or alternatively may include a magnetic stripe zone 98 and/or 99 similar to magnetic stripe zone 80 and/or 84, respectively, illustrated in FIG. 4.

Data storage cards 60, for purposes of this disclosure, is further intended to include cards having data and information encoded in a semiconductor memory, such as found in Personal Computer cards (“PC”), or Personal Computer Memory Card International Association cards (“PCMCIA”).

Data storage cards 60 is still further intended to include driver licenses, identification cards, airline tickets, transit cards, and the like.

Referring now more particularly to FIGS. 1-2A, and 7, protective sleeve or jacket for data storage cards, hereinafter “jacket 10”, comprises a flexible planar body 20 comprising an interior space 24. The planar body 20 further comprises an open side edge 22 providing direct, open, unobstructed passage to the interior space 24. More specifically, the jacket 10 comprises an elongated, flexible planar body 20 comprising a front panel 30 and a rear panel 40, the panels 30 and 40 each comprising a shape consistent with the shape of the data storage card, e.g., rectangular, as illustrated herein.

The jacket 10 is constructed from a flexible, clear, or transparent non-ferromagnetic or non-magnetically attractive sheet of material configured to allow passage/transmission of signals, such as magnetic signals, output from the data storage card 60 to a data storage card reader 100. Suitable construction materials may include a plastic or polymer material such as including, but not limited to polyvinyl chloride (PVC), polypropylene, and polyethylene. The transparent plastic sheet is then modified in shape, for example, is die-cut into a shape, such as a rectangle shape defining a standardized data storage card 60 size.

The selected construction material for jacket 10 further provides, contemporaneously with the readability by reader 100 function disclosed above, a means for “cleaning” the “smeared” and corrupted data and information, thereby allowing a previously unreadable data storage card 60 to be read by a data storage card reader 100 while card 60 is fully inserted, and properly housed in the jacket 10. Thus, the jacket 10 is adapted and configured for allowing a data storage card 60 to be read by a data storage card reader 100 or reading device while being fully inserted and properly housed in the jacket 10. The means for cleaning the smeared and corrupted data and information is disclosed herein as a data reader adapter 110 which functions as a spatially-optimized data prioritizer 112. The data reader adapter 110 or prioritizer 112 “cleans” smeared and corrupted data and information by providing the optimal space/distance between the encoding section 78, circuit panel, or bar code 62 of the data storage card 60 and the reading head assembly (e.g., reading head assembly 103 of terminal 102 of FIG. 6A) of the data storage card reader 100 which weakens the signal reception field (e.g., magnetic field) between the card 60 and reader 100 to a level causing the smeared and corrupted data and information to be non-readable by the reader 100, and concurrently or in conjunction, allowing the non-smeared and non-corrupted data and information data of the card 60 to be readable by the reader 100, thereby allowing the card 60 to be successfully read by reader 100.

The front panel 30 comprises a top edge 32, a bottom edge 34, a first side edge 36, and a second side edge 38 opposing the first side edge 36. The front panel 30 further includes an inner surface 31 and an outer surface 33.

The rear panel 40 comprises a top edge 42, a bottom edge 44, a first side edge 46, and a second side edge 48 opposing the first side edge 46. The rear panel 40 further includes an inner surface 41 and an outer surface 43.

The top edges 32, 42 and bottom edges 34, 44 of the front and rear panels 30 and 40, respectively, are sealed, and the first side edges 36, 46 of the front and rear panels 30 and 40, respectively are sealed forming an interior cavity 50 within which a data storage card 60 is slidably inserted and removably held therein in a snug-fit manner. Sealing of the front and rear panels 30 and 40 in the manner as previously described forms the unitary planar body 20. The second side edges 38 and 48 of the first and second 30 and 40, respectively, are unsealed, thus providing the open side edge 22 of jacket 10 which provides open, direct access into the interior cavity 50.

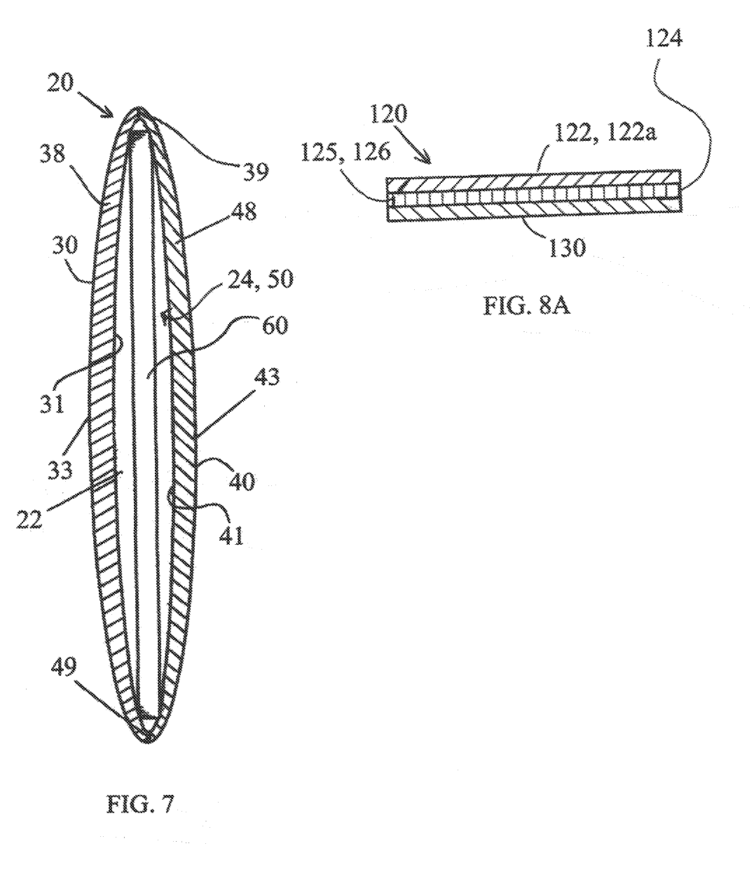

In particular reference to FIG. 7, the top edge 32 of the front panel 30 is sealed to the top edge 42 of the rear panel 40 at first interface 39, and the bottom edge 34 of the front panel 30 is sealed to the bottom edge 44 of the rear panel 40 at second interface 49. When inserting a data storage card 60 into the jacket 10, the open side edge 22 thereof is sized and configured so as to be open longitudinally, from first interface 39 to second interface 49, to dimensionally accommodate and enable the data storage card 60, about an edge 61, 63 or side edge 65, 67 thereof, to be slidably inserted through the open side edge 22 and into the interior cavity 50 within which the card 60 is snugly received and removably held in a protected and completely covered, or substantially completely covered manner.

The second side edges 38, 48 of the front and rear panels 30 and 40, respectively, preferably include a concave recess 38a, 48a formed therein, thereby providing the jacket 10 with an arcuate or semicircular gain 26 or notch. The concave recesses 38a and 48a are formed along respective second side edges 38 and 48 so as to be oriented distally above or below the magnetic stripe zone. When fully inserted into the jacket 10, a small portion of the data storage card 60 remains visible through the gain 26, and thus easily grasped by the index finger and thumb of user. The gain 26 facilitates insertion and removal of a data storage card 60. The concave recesses 38a, 48a formed in the front and rear panels 30 and 40, respectively, enable the obverse and converse sides or surfaces of the data storage card 60 to be grasped for removal when desired and also facilitate complete entry of the card 60 into the jacket 10.

The sealing of the selected plastic sheeting material, in accordance to one embodiment, can be accomplished in any one of a number of known or conventional processes, including but not limited to radio frequency (RF) or microwave heat sealing, induction heat sealing, heat convection sealing, or ultrasonic vibration heat sealing.

The thickness and construction material of each panel 30 and 40 of the jacket 10 are critical to the present invention to facilitate desired protection in conjunction with allowing readability of card 60 housed inside jacket 10 by a card reading device 100. For purposes of this disclosure, the term “mils” means and refers to the U.S. imperial measurement, wherein e.g., the imperial measurement 1 mil equals 0.001 inches, or one thousandth of an inch.

The front panel 30 comprises a thickness measuring approximately between 1.00 mils to 2.75 mils (25.40 microns to 69.85 microns), preferably between 1.30 mils to 2.45 mils (33.02 microns to 62.23 microns), and most preferably 1.88 mils (47.75 microns).

The rear panel 40 comprises a thickness measuring approximately between 1.00 mils to 2.75 mils (25.40 microns to 69.85 microns), preferably between 1.30 mils to 2.45 mils (33.02 microns to 62.23 microns), and most preferably 1.88 mils (47.75 microns).

The front panel 30 may be constructed with different thickness than a thickness of the rear panel 40.

The jacket 10 comprises a thickness measuring approximately between 2.00 mils to 5.50 mils (50.80 microns to 139.70 microns), preferably between 2.60 mils to 4.90 mils (66.04 microns to 124.46 microns), and most preferably 3.76 mils (95.50 microns).

The unique, unanticipated, and nonobvious data reader adapter 110 of the present invention, which functions as a spatially-optimized data prioritizer 112, is defined by the thickness and construction material comprising each panel 30 and 40 of the jacket 10, and thus the thickness and construction material of said panels 30 and 40 are critical to the present invention to facilitate the desired card 60 protection in conjunction with allowing readability of the data storage card 60 while housed inside the jacket 10 by a card reading device 100.

Hence, the jacket 10 is adapted and configured for allowing a data storage card 60 to be read by a data storage card reader 100 or reading device while being fully inserted, and properly housed in the jacket 10, as shown in FIG. 2.

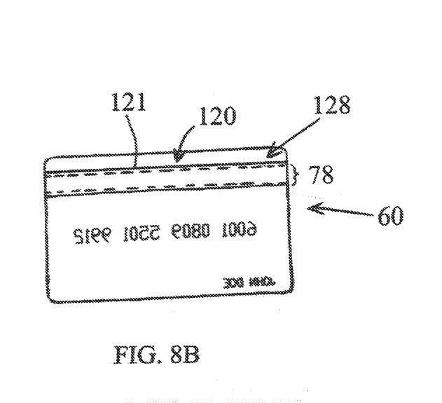

Referring now to FIGS. 8A-8B, in accordance to another embodiment of the present invention, a spacer device 120 is disclosed which allows data storage cards 60 containing particular degrees of corrupted or smeared data to be successfully read by a corresponding card reader 100.

In accordance to one embodiment, the spacer device 120 comprises a flexible, 2-ply substrate 121 or media in the form of an elongated strip 128 being sized and configured to completely cover the magnetic or optical data storage device (e.g., encoding section 78 shown as area defined by dashed lines) and/or circuitry incorporated with data storage cards 60, such as including but not limited to a wide and/or narrow magnetic stripe zone 80, 84 disposed on a financial or non-financial card, integrated circuits or circuit panels, such as the integrated circuit 96 provided on the Smart Card 90 shown in FIG. 5, and a bar code, such as the bar code 62 disposed along the converse side 76 of the debit card 70a shown in FIG. 4A.

The 2-ply substrate 121 or media comprises a top layer 122 and a bottom layer 124, the top layer 122 comprising a flexible, clear, or transparent non-ferromagnetic or non-magnetically attractive membrane 122a of material configured to allow passage/transmission of signals, such as magnetic signals, therethrough. Suitable membrane 122a construction materials may include a plastic or polymer material such as including, but not limited to polyvinyl chloride (PVC), polypropylene, and polyethylene.

The bottom layer 124 comprises a pressure-sensitive adhesive 125, the adhesive 125 comprising an adhesive coating 126 constructed from a clear or transparent non-ferromagnetic or non-magnetically attractive material configured to allow passage/transmission of signals, such as magnetic signals, therethrough. The adhesive 125 allows the spacer device 120 to be releasably attached to a data storage card 60, as illustrated in FIG. 8B.

A removable release liner 130 covers the outer side of the adhesive 125 in order to afford protection thereto until desired use. The removable release liner 130 is readily peelable from the adhesive 125 and does not remove the adhesive coating 126 therefrom. The removable release liner 125 is formed of a relatively inert material in order to prevent contamination of the adhesive coating 126 or any other portion of the spacer device 120. Once the release liner 80 is removed from adhesive 125, the adhesive 125 is engaged against the surface or side 72 or 76 of the card 60 disposed with an encoding section 78 in a manner such that the spacer device 120 completely covers the encoding section 78.

The thickness and construction material of each the 2-ply substrate 121 or media of the top layer 122 and bottom layer 124 of the 2-ply substrate 121 is critical, and thus the thickness and construction material are critical to the present invention to facilitate the desired card 60 protection in conjunction with allowing readability of the data storage card 60 when spacer device 120 is releasably attached thereto.

The membrane 122a comprises a thickness measuring approximately between 0.75 mils to 2.75 mils (19.05 microns to 69.85 microns), preferably between 1.20 mils to 2.40 mils (30.48 microns to 60.96 microns), and most preferably 1.75 mils (44.45 microns).

The pressure-sensitive adhesive 125 comprises a thickness measuring approximately between 0.25 mils to 2.25 mils (6.35 microns to 57.15 microns), preferably between 0.75 mils to 1.75 mils (19.05 microns to 44.45 microns), and most preferably 1.65 mils (41.91 microns).

Releasable attachment of the spacer device 120 atop the data storage area or zone of a data storage card 60 having smeared and corrupted data and information, and where such card 60 is unreadable by a data storage card reader 100, allows such damaged card 60 to be successfully read by the data storage card reader 100.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A protective jacket for data storage cards, the jacket comprises:
a flexible planar body, the planar body comprising:
an interior space; and
an open side edge providing direct, unobstructed passage to the interior space.

2. The jacket of claim 1, wherein the body is constructed from a flexible transparent non-ferromagnetic or non-magnetically attractive sheet of material configured to allow passage and transmission of signals from a data storage card to a data storage card reader.

3. A protective jacket for data storage cards, the jacket comprises:
a flexible planar body, the planar body comprising:
a front panel, the front panel comprises a top edge, a bottom edge, a first side edge, a second side edge opposing the first side edge, an inner surface, and an outer surface; and
a rear panel, the rear panel comprises a top edge, a bottom edge, a first side edge, a second side edge opposing the first side edge, an inner surface and an outer surface.

4. The jacket of claim 3, wherein the top edge of the front panel and the top edge of the rear panel are sealed, the bottom edge the front panel and the bottom edge of the rear panel are sealed, the first side edge of the front panel and the first side edge of the rear panels are sealed forming an open side edge and an interior cavity, the open side edge providing direct, open and unobstructed passage into the interior cavity within which a data storage card is slidably insertable and removably held in a snug-fit manner.

5. The jacket of claim 3, wherein the front panel and the rear panel are each constructed from a flexible transparent non-ferromagnetic or non-magnetically attractive sheet of material configured to allow passage and transmission of signals from a data storage card to a data storage card reader.

6. The jacket of claim 5, wherein the front panel comprises a thickness measuring approximately between 1.00 mils to 2.75 mils.

7. The jacket of claim 5, wherein the rear panel comprises a thickness measuring approximately between 1.00 mils to 2.75 mils.

8. The jacket of claim 3, further comprising means for allowing a data storage card having smeared and corrupted data and information, and being unreadable by a data storage card reader to be successfully read by the data storage card reader.

9. The jacket of claim 8, wherein the means for allowing a data storage card having smeared and corrupted data and information to be successfully read by a data storage card reader comprises a reader adapter.

10. The jacket of claim 9, wherein the reader adapter comprises a spatially-optimized data prioritizer.

11. A spacer device for protecting one or more data storage zones of a data storage card, the spacer device comprises:
a flexible, 2-ply substrate, the substrate releasably attaches to a surface of the data storage card, the surface being disposed with the one or more data storage zones of the data storage card, the substrate protecting and allowing both a data storage card having an undamaged data storage zone and a data storage card having smeared and corrupted data and information to be successfully read by the data storage card reader.

12. The spacer device of claim 11, wherein the substrate comprises a top layer and a bottom layer, the top layer comprising a flexible, clear or transparent non-ferromagnetic or non-magnetically attractive membrane of material, the material of the membrane allows passage/transmission of signals therethrough, the bottom layer comprising a pressure-sensitive adhesive, the adhesive comprising an adhesive coating constructed from a clear or transparent non-ferromagnetic or non-magnetically attractive material, the adhesive coating material allows passage/transmission of signals therethrough, and wherein the adhesive facilitates releasable attachment of the spacer device to the data storage card.

13. The spacer device of claim 11, wherein the substrate completely covers the data storage zone.

14. The spacer device of claim 12, wherein the membrane is constructed of a plastic or polymer material.

15. The spacer device of claim 14, wherein the membrane comprises a thickness measuring approximately between 0.75 mils to 2.75 mils.

16. The spacer device of claim 12, wherein the adhesive comprises a thickness measuring approximately between 0.25 mils to 2.25 mils.

17. The spacer device of claim 12, further comprising a removable release liner, the removable release liner covers an outer side of the adhesive, the removable release liner is readily peelable from the adhesive.
